(19) United States
(12) Patent Application Publication
(10) Pub. No.: US 2026/0317076 A1
(43) Pub. Date: Oct. 15, 2026

(54) CONVEYING APPARATUS

(71) Applicant: ISUZU MOTORS LIMITED, Yokohama-shi (JP)

(72) Inventor: Hidemi SASAKI, Fujisawa-shi (JP)

(21) Appl. No.: 19/465,232

(22) Filed: Jan. 30, 2026

(30) Foreign Application Priority Data
Mar. 12, 2025 (JP) 2025-039476

(51) Int. Cl. B65G 47/248; B65G 15/30; G01N 21/95

(52) U.S. Cl. CPC B65G 47/248; B65G 15/30; G01N 21/95

(57) ABSTRACT

A conveying apparatus includes: a conveying belt that conveys a battery cell; an inspection unit that inspects an outer peripheral surface of the battery cell positioned at an inspection position; a plurality of rollers that can come into contact with the outer peripheral surface of the battery cell positioned at the inspection position; a support unit that rotatably supports the plurality of rollers disposed about a first rotation axis; a first rotation mechanism that rotates each of the plurality of rollers, thereby rotating the battery cell; and a second rotation mechanism that rotates the support unit together with the plurality of rollers about the first rotation axis in conjunction with the movement of the conveying belt.

### CROSS-REFERENCE TO RELATED APPLICATIONS

The present application claims priority to Japanese Patent Applications number 2025-39476, filed on March 12, 2025 contents of which are incorporated herein by reference in their entirety.

### BACKGROUND OF THE INVENTION

The present disclosure relates to a conveying apparatus for conveying battery cells. Japanese Unexamined Patent Application Publication No. 2020-188004 discloses a conveying apparatus for conveying battery cells to be inspected. The conveying apparatus includes: a conveyor that conveys the battery cells; and an inspection stage to which the battery cells are transferred from the conveyor, and transfers the laterally oriented battery cells from the conveyor to the inspection stage.

However, in the above-described conveying apparatus, the battery cells need to be transferred between the conveyor and the inspection stage, which undesirably increases the time required for conveying and inspecting the battery cells.

### BRIEF SUMMARY OF THE INVENTION

The present disclosure has been made in view of these points, and an object of the present disclosure is to inspect a battery cell, while being transported, in a short time.

One aspect of the present disclosure provides a conveying apparatus including: a conveying belt that conveys a cylindrical battery cell by moving, with the battery cell being oriented horizontally; an inspection unit that inspects an outer peripheral surface of

the battery cell when the battery cell is positioned at an inspection position in a conveying direction; a plurality of rollers that can come into contact with the outer peripheral surface of the battery cell positioned at the inspection position at positions that are spaced apart from each other in a circumferential direction; a support unit that rotatably supports the plurality of rollers disposed about a first rotation axis; a first rotation mechanism that rotates each of the plurality of rollers that are in contact with the outer peripheral surface about a second rotation axis of each of the rollers, thereby rotating the battery cell; and a second rotation mechanism that rotates the support unit together with the plurality of rollers about the first rotation axis in conjunction with movement of the conveying belt.

### BRIEF DESCRIPTION OF THE DRAWINGS

FIG. 1 schematically shows a configuration of a conveying apparatus 1 according to an embodiment.

FIG. 2 is a schematic view showing a positional relationship among a conveying belt 3, an inspection unit 6, and a rotation unit 10.

FIG. 3 is a schematic view showing a rotation state of a battery cell 90 positioned at an inspection position.

FIG. 4 is a schematic view showing a cross section taken along line A-A of FIG. 3.

FIG. 5 is a schematic view for explaining revolution of a roller group 12.

FIG. 6 is a schematic view showing a planar configuration of the rotation unit 10.

FIG. 7 is a schematic view showing a cross section taken along line B-B of FIG. 6.

FIG. 8 is a schematic view showing a cross section taken along line C-C of FIG. 6.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### An outline of a conveying apparatus

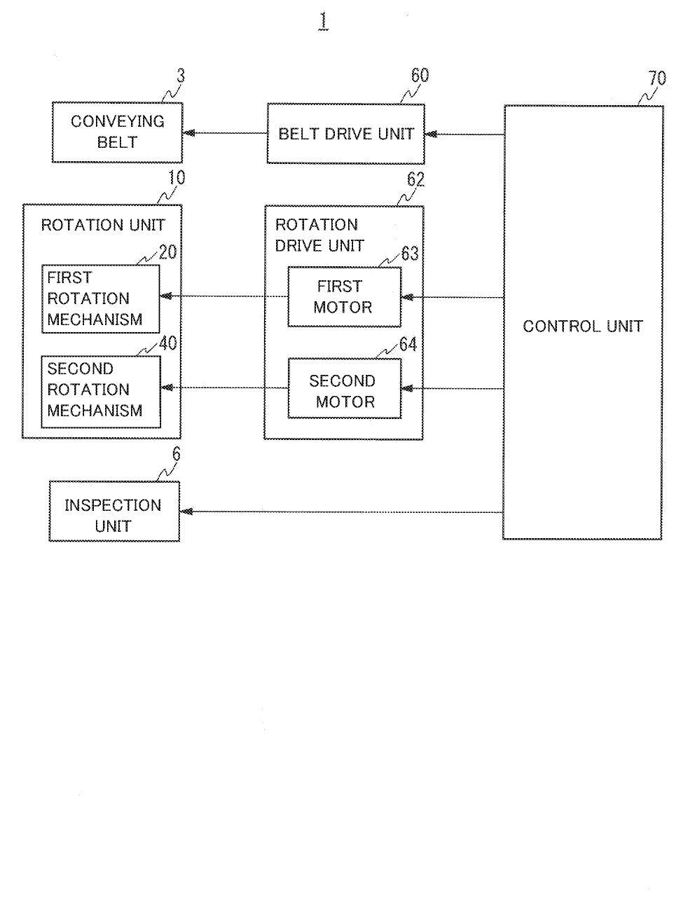

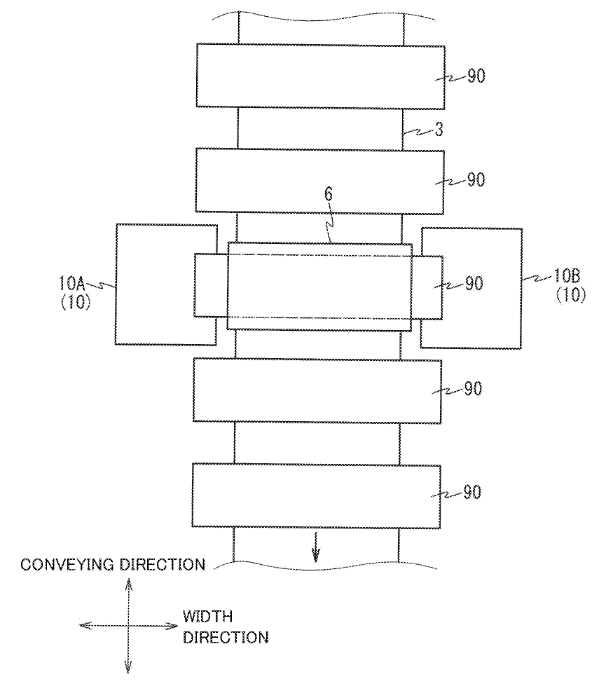

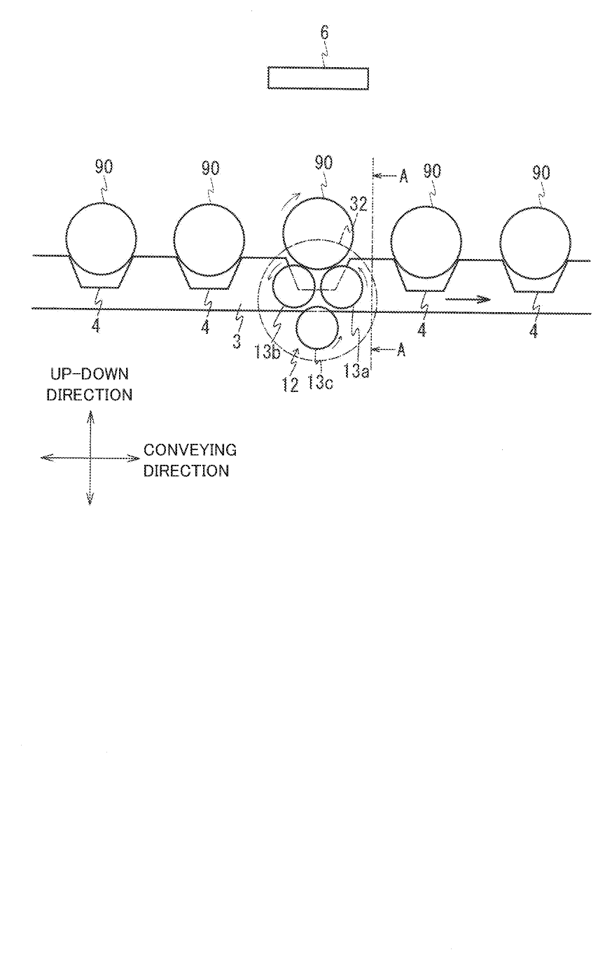

FIG. 1 is a schematic diagram illustrating a configuration of a conveying apparatus 1 according to one embodiment. FIG. 2 is a schematic diagram illustrating a positional relationship among a conveying belt 3, an inspection unit 6, and a rotation unit 10. FIG. 3 is a schematic view showing a rotation state of a battery cell 90 positioned at an inspection position. In FIG. 3, for convenience of description, a part of the configuration of the rotation unit 10 (a contact roller that contacts the outer peripheral surface of the battery cell 90) is illustrated.

The conveying apparatus 1 is an apparatus that inspects a plurality of battery cells 90 while conveying the plurality of battery cells 90 in a conveying direction. The conveying apparatus 1 is provided, for example, in a manufacturing line for assembling a battery pack from the plurality of battery cells 90. As illustrated in FIG. 1, the conveying apparatus 1 includes the conveying belt 3, the inspection unit 6, the rotation unit 10, and a control unit 70.

As shown in FIG. 2, the conveying belt 3 conveys the battery cell 90 along the

conveying direction. The conveying belt 3 conveys the cylindrical battery cell 90 by moving, with the cylindrical battery cell 90 being oriented horizontally. The plurality of battery cells 90 are placed on a conveying surface of the conveying belt 3 at predetermined intervals in the conveying direction. After conveying the plurality of battery cells 90 to the inspection position, the conveying belt 3 conveys the battery cells 90 to an assembly unit located downstream of the inspection position. In the assembly unit, a battery pack is assembled from the plurality of battery cells 90.

The conveying belt 3 includes a concave portion 4 provided along a width direction orthogonal to the conveying direction. As shown in FIG. 3, a plurality of concave portions 4 are formed on the conveying surface of the conveying belt 3 at predetermined intervals along the conveying direction. The plurality of concave portions 4 hold the battery cells 90 being transported. Therefore, the conveying belt 3 conveys the battery cell 90 in contact with the concave portion 4 in the conveying direction.

As illustrated in FIG. 3, the inspection unit 6 is provided above the inspection position in the conveying direction, and inspects the outer peripheral surface of the battery cell 90. The inspection unit 6 inspects the outer peripheral surface of the battery cell 90 when the battery cell 90 is positioned at the inspection position. The inspection unit 6 includes, for example, a light-emitting unit and a light-receiving unit, and performs inspection by receiving a reflected light from the outer peripheral surface of the battery cell 90. The inspection unit 6 inspects flatness, scratches, and the like of the outer peripheral surface, and measures a length of the battery cell 90.

The rotation unit 10 is a unit for rotating the battery cell 90 positioned at the inspection position. For example, the rotation unit 10 rotates the battery cell 90 positioned at the inspection position by one or more rotations. Thus, the inspection unit 6 can inspect the entire outer peripheral surface of the battery cell 90 positioned at the inspection position. The rotation unit 10 rotates the battery cell 90 with both axial end portions of the battery cell 90 being supported.

As shown in FIG. 2, the rotation unit 10 includes a first-end rotation unit 10A and a second-end rotation unit 10B. The first-end rotation unit 10A is provided at one end in the width direction of the conveying belt 3, and the second-end rotation unit 10B is provided at the other end in the width direction of the conveying belt 3. The first-end rotation unit 10A rotates the battery cell 90 with one axial end portion of the battery cell 90 being supported. The second-end rotation unit 10B rotates the battery cell 90 with the other axial end portion of the battery cell 90 being supported. The first-end rotation unit 10A and the second-end rotation unit 10B perform rotation simultaneously. Since the configuration of the first-end rotation unit 10A and the configuration of the second-end rotation unit 10B are the same, hereinafter, they will be collectively referred to simply as the rotation unit 10.

The battery cell 90 positioned at the inspection position is rotated by rotation of a plurality of contact rollers (two of rollers 13a, 13b, and 13c in FIG. 3) of the rotation unit 10. The inspection unit 6 inspects the outer peripheral surface of the battery cell 90 during the rotation of the plurality of contact rollers. A detailed configuration of the rotation unit 10 will be described later.

The control unit 70 controls the operation of the conveying apparatus 1. The control unit 70 causes a belt drive unit 60 that drives the conveying belt 3 to operate, thereby controlling conveyance of the battery cell 90 by the conveying belt 3. The control unit 70 causes a rotation drive unit 62 that drives the rotation unit 10 to operate, thereby controlling rotation of the battery cell 90 by the rotation unit 10. The control unit 70 causes the inspection unit 6 to operate, thereby inspecting the outer peripheral surface of the battery cell 90 that is rotating. The control unit 70 causes the conveying belt 3, the inspection unit 6, and the rotation unit 10 to operate so as to alternately perform the conveyance of the battery cell 90 and the inspection of the battery cell 90.

### Detailed configuration of the rotation unit

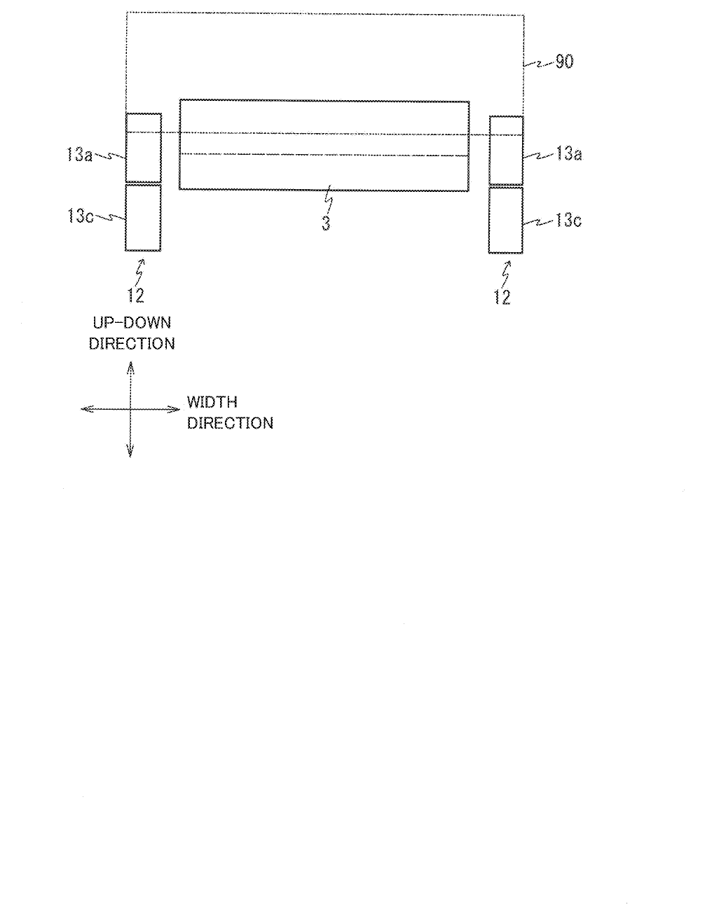

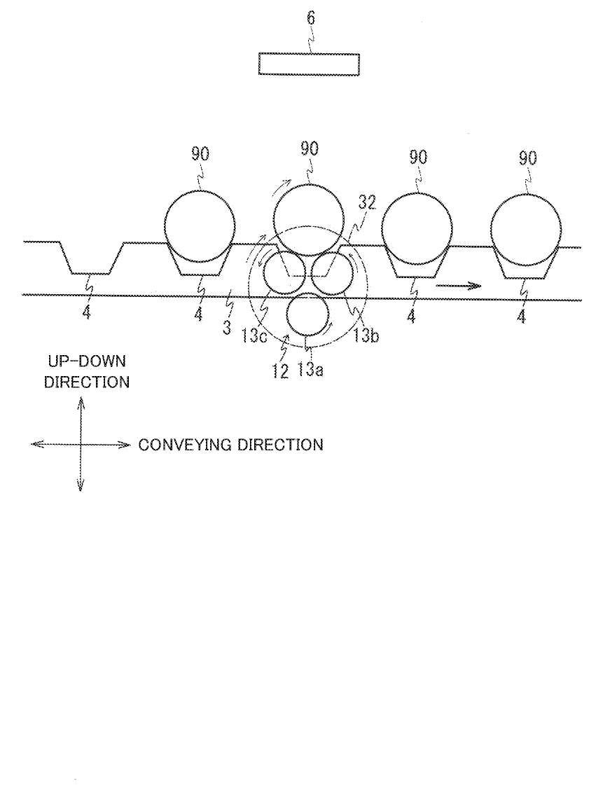

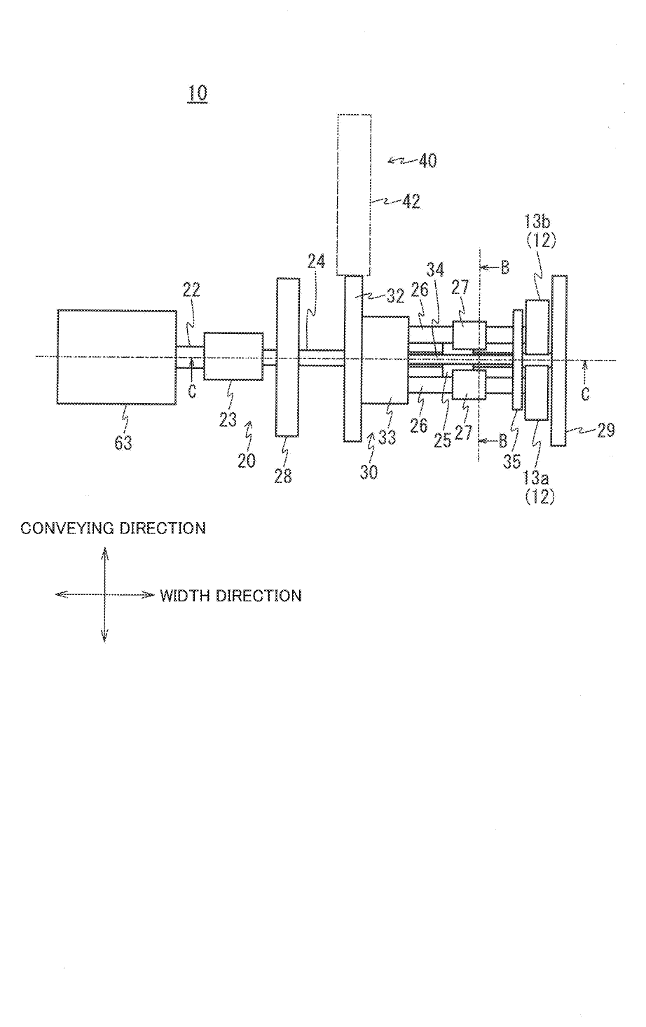

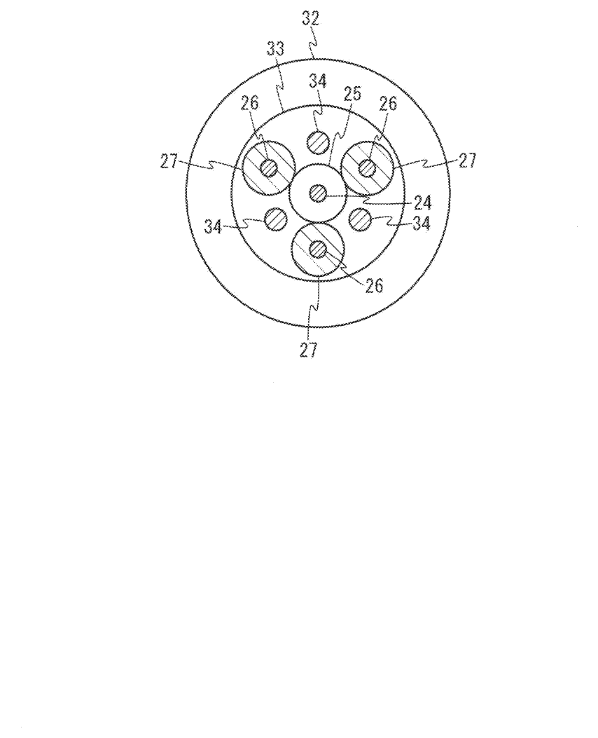

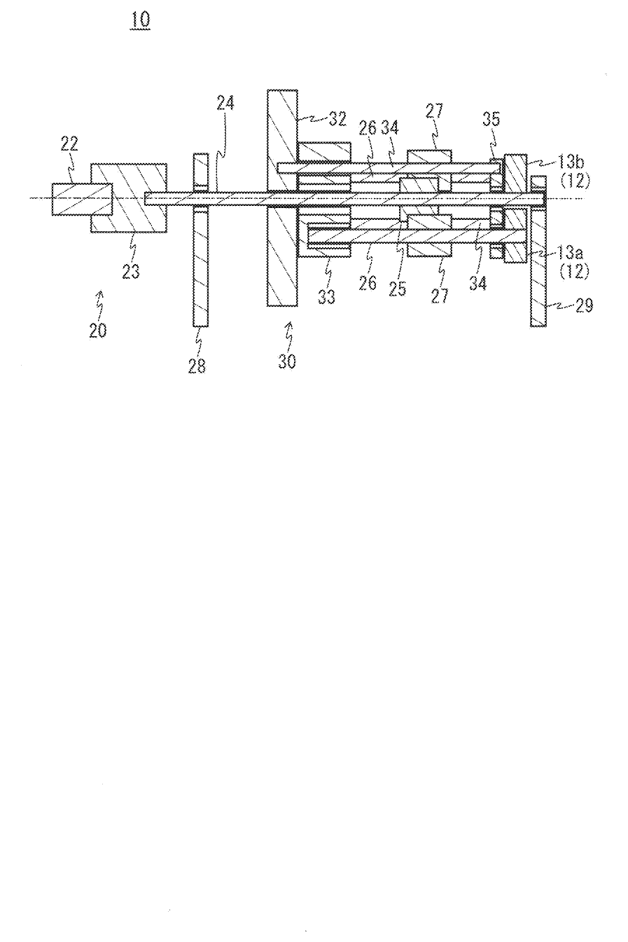

A detailed configuration of the rotation unit 10 will be described with reference to FIGS. 3 to 8. FIG. 4 is a schematic view showing a cross section taken along line A-A of FIG. 3. FIG. 5 is a schematic view for explaining revolution of a roller group 12. FIG. 6 is a schematic diagram illustrating a planar configuration of the rotation unit 10. FIG. 7 is a schematic view showing a cross section taken along line B-B of FIG. 6. FIG. 8 is a schematic view showing a cross section taken along line C-C of FIG. 6. In FIGS. 4 and 5, as in FIG. 3, only a part of the configuration of the rotation unit 10 is shown.

As shown in FIG. 6, the rotation unit 10 includes the roller group 12, a first rotation mechanism 20, a support unit 30, and a second rotation mechanism 40. As shown in FIG. 3, the roller group 12 is a plurality of rollers that can contact the outer peripheral surface of the battery cell 90 positioned at the inspection position. The roller group 12 here has three rollers 13a, 13b, and 13c. The three rollers 13a to 13c are rotatably provided about a gear shaft 26 (second rotation shaft). The three rollers 13a to 13c are provided at predetermined intervals in a circumferential direction around a rotation shaft of the support unit 30.

Two rollers among the three rollers 13a to 13c are a pair of contact rollers that contact the outer peripheral surface at one axial end portion of the battery cell 90 positioned at the inspection position. In FIG. 3, the two rollers 13a and 13b are the contact rollers. The two rollers 13a and 13b are in contact with the outer peripheral surface of the battery cell 90 at positions that are spaced apart from each other in the circumferential direction of the battery cell 90.

When the battery cell 90 conveyed by the conveying belt 3 reaches the inspection position, the battery cell 90 is spaced apart from the concave portion 4 of the conveying belt 3 and comes into contact with the contact rollers (rollers 13a and 13b), as shown in FIG. 3. Accordingly, the plurality of rollers 13a and 13b can rotate the battery cell 90 positioned at the inspection position.

As the two rollers 13a and 13b rotate, the battery cell 90 positioned at the inspection position is caused to rotate. Specifically, as shown in FIG. 3, when the rollers 13a and 13b rotate counterclockwise, the battery cell 90 rotates clockwise. Then, when the battery cell 90 makes one rotation, the inspection unit 6 can inspect the entire outer peripheral surface of the battery cell 90.

The two rollers 13a and 13b support, in a sandwiched manner, the outer peripheral surface at one axial end portion of the battery cell 90. This enables the two rollers 13a and 13b to more easily support the battery cell 90 in a state parallel in the width direction, so that inspection of the outer peripheral surface by the inspection unit 6 is appropriately performed.

The contact rollers are switched by the rotation of the support unit 30 that supports the roller group 12. For example, when one battery cell 90 is positioned at the inspection position, two rollers 13a and 13b become the contact rollers, and when the next battery cell 90 is positioned at the inspection position, two rollers 13b and 13c are switched to the contact rollers, as shown in FIG. 5.

The roller group 12 of the second-end rotation unit 10B rotates at the same timing as the roller group 12 of the first-end rotation unit 10A. That is, the contact rollers provided at both ends in the width direction of the conveying belt 3 come into contact with the outer peripheral surface at both axial end portions of the battery cell 90, thereby rotating the battery cell 90.

The first rotation mechanism 20 rotates the roller group 12. Specifically, the first rotation mechanism 20 rotates each of the three rollers 13a to 13c constituting the roller group 12 about the gear shaft 26 (second rotation shaft). As a result, the three rollers 13a to 13c rotate about their own axes in the same direction.

As illustrated in FIG. 6, the first rotation mechanism 20 includes a drive shaft 22, a driven shaft 24, a first gear 25, the gear shaft 26, and a second gear 27. The drive shaft 22 is rotatably coupled to a first motor 63 serving as a drive source. The drive shaft 22 is coupled to the driven shaft 24 by a coupling 23. The driven shaft 24 rotates in conjunction with the drive shaft 22. The driven shaft 24 is rotatably supported by a first bracket 28 and a second bracket 29 via bearings. The driven shaft 24 passes through the support unit 30 (specifically, a gear portion 32 and a support portion 33).

The first gear 25 is provided at the driven shaft 24 and rotates together with the driven shaft 24. The second gear 27 meshes with the first gear 25. Here, three second gears 27 are provided around the first gear 25, and as shown in FIG. 7, the three second gears 27 mesh with the first gear 25.

The gear shaft 26 is three shafts that support the second gears 27. The rollers 13a to 13c are attached at one axial end portion of each of the three gear shafts 26. The other axial end portions of the three gear shafts 26 are supported by the support portion 33.

With the above configuration of the first rotation mechanism 20, when the first motor 63 rotates, the three rollers 13a to 13c rotate about their own axes in the same direction in conjunction with the rotation of the three second gears 27.

As described above, when the two contact rollers contacting the outer circumferential surface of the battery cell 90 rotate, the battery cell 90 also rotates. Therefore, the first rotation mechanism 20 rotates each of the plurality of contact rollers that are in contact with the outer peripheral surface about the gear shaft 26, thereby causing the battery cell 90 to rotate.

The support unit 30 supports the roller group 12. The support unit 30 rotates about the driven shaft 24 (first rotation shaft) while supporting the roller group 12. A rotation direction of the support unit 30 is clockwise, and is opposite to a rotation direction of each of the rollers 13a to 13c of the roller group 12.

The support unit 30 is rotatable about the driven shaft 24 at predetermined intervals in the circumferential direction. For example, the support unit 30 rotates at intervals of 120° in the circumferential direction. As a result, two of the contact rollers among the three rollers 13a to 13c come into contact with the outer peripheral surface of the battery cell 90. That is, each time the support unit 30 rotates by the predetermined interval, two contact rollers, among the three rollers 13a to 13c, that contact the outer peripheral surface are switched.

As illustrated in FIG. 6, the support unit 30 includes the gear portion 32, the support portion 33, a coupling shaft 34, and a coupling plate 35. The gear portion 32 is a portion that meshes with a gear 42 of the second rotation mechanism 40, and is rotatable. The driven shaft 24 passes through the center of the gear portion 32. The support portion 33 is coupled to the gear portion 32. One axial end portion of the gear shaft 26 is supported by the support portion 33. The gear portion 32 rotates clockwise as shown in FIG. 5.

The coupling shaft 34 is a shaft that couples the gear portion 32 and the coupling plate 35. Here, three coupling shafts 34 are provided, and are located between the three gear shafts 26 in the circumferential direction as shown in FIG. 7. One axial end portion of the coupling shaft 34 is coupled to the gear portion 32, and the other axial end portion of the coupling shaft 34 is coupled to the coupling plate 35. The coupling plate 35 rotates together with the gear portion 32 coupled via the coupling shaft 34. That is, when the gear portion 32 rotates, the coupling plate 35 also rotates in the same direction.

With the configuration of the support unit 30 described above, when the gear portion 32 rotates clockwise, the rollers 13a to 13c that rotate counterclockwise about their own axes also revolve clockwise (see FIG. 5). Specifically, the rollers 13a to 13c revolve clockwise about the driven shaft 24. Due to the rollers 13a to 13c revolving clockwise, the two contact rollers among the rollers 13a to 13c are more likely to smoothly come into contact with the battery cell 90 that is conveyed by the conveying belt 3 and reaches the detection position.

The second rotation mechanism 40 rotates the support unit 30 that supports the roller group 12. The second rotation mechanism 40 rotates the support unit 30 during the rotation of the plurality of rollers 13a to 13c. The second rotation mechanism 40 includes, for example, the gear 42 that meshes with the gear portion 32 of the support unit 30. A driving force is transmitted from a second motor 64 (FIG. 1) to the gear 42. As the second motor 64 rotates, the driving force generated by the second motor 64 is transmitted to the gear portion 32 via the gear 42. As the gear portion 32 rotates, the support unit 30 is caused to rotate.

The second rotation mechanism 40 rotates the support unit 30 together with the roller group 12 about the driven shaft 24 in conjunction with the movement of the conveying belt 3. Specifically, when the battery cell 90 to be inspected reaches the inspection position, the second rotation mechanism 40 rotates the support unit 30. Accordingly, the battery cell 90 positioned at the inspection position rotates immediately, thereby enabling inspection of the outer peripheral surface of the battery cell 90 to be performed quickly.

The control unit 70 controls operations of the belt drive unit 60 and the second motor 64 so that a moving speed of the battery cell 90 positioned at the inspection position by revolution of the contact rollers of the roller group 12 becomes equal to a moving speed of the conveying belt 3. Accordingly, when the battery cell 90 reaches the inspection position, an impact associated with the contact of the contact rollers with the outer peripheral surface of the battery cell 90 can be minimized, and when the battery cell 90 leaves the inspection position, an impact associated with the contact of the conveying belt 3 with the battery cell 90 can be minimized. As a result, wear of the rollers 13a to 13c of the roller group 12 and the conveying belt 3 can be suppressed.

The control unit 70 controls operations of the first motor 63 and the second motor 64 so that the rollers 13a to 13c revolve by rotating the support unit 30 while the rollers 13a to 13c are rotating about their own axes. Here, by appropriately designing a gear ratio between the first gear 25 and the second gear 27 and a rotation speed of the drive shaft 22, an angular velocity of self-rotation of the rollers 13a to 13c and the battery cell 90 positioned at the inspection position can be made approximately zero without changing the rotation speed of the drive shaft 22 during the rotation of the support unit 30. Accordingly, when the battery cell 90 comes into contact with the contact rollers or when

the battery cell 90 after the inspection comes into contact with the conveying belt 3, the peripheral speed of the battery cell 90 and the rollers 13a to 13c become approximately zero. As a result, wear at contact points between the battery cell 90 and the contact rollers and the conveying belt 3 can be suppressed, and it is possible to prevent the battery cell 90 from rolling due to friction at the time of contact and separating from the contact rollers and the concave portion 4 of the conveying belt 3. In addition, inspection of the plurality of battery cells 90 conveyed by the conveying belt 3 can be easily performed within a short time.

In the above description, the roller group 12 that can come into contact with the outer peripheral surface of the battery cell 90 includes three rollers 13a to 13c, but the present embodiment is not limited thereto. For example, the roller group 12 may include two rollers or four or more rollers.

### Effects of the embodiment

The conveying apparatus 1 of the above-described embodiment includes: the plurality of contact rollers (rollers 13a to 13c) that can contact the outer peripheral surface of the battery cell 90 positioned at the inspection position; the support unit 30 that supports the plurality of contact rollers; the first rotation mechanism 20 that rotates each of the plurality of contact rollers about their own axes, thereby causing the battery cell 90 to rotate; and the second rotation mechanism 40 that rotates the support unit together with the plurality of contact rollers in conjunction with the movement of the conveying belt 3. As a result, the plurality of contact rollers (rollers 13a to 13c) rotating the battery cells 90 revolve in conjunction with the movement of the conveying belt 3, and the inspection of the plurality of battery cells 90 conveyed by the conveying belt 3 can be performed quickly.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Furthermore, new exemplary embodiments generated by arbitrary combinations of them are included in the exemplary embodiments. Furthermore, effects of the new exemplary embodiments brought by the combinations also have the effects of the original exemplary embodiments.

What is claimed is:

1. A conveying apparatus comprising:
a conveying belt that conveys a cylindrical battery cell by moving, with the battery cell being oriented horizontally;
an inspection unit that inspects an outer peripheral surface of the battery cell when the battery cell is positioned at an inspection position in a conveying direction;
a plurality of rollers that can come into contact with the outer peripheral surface of the battery cell positioned at the inspection position at positions that are spaced apart from each other in a circumferential direction;
a support unit that rotatably supports the plurality of rollers disposed about a first rotation axis;
a first rotation mechanism that rotates each of the plurality of rollers that are in contact with the outer peripheral surface about a second rotation axis of each of the rollers, thereby rotating the battery cell; and
a second rotation mechanism that rotates the support unit together with the plurality of rollers about the first rotation axis in conjunction with movement of the conveying belt.

2. The conveying apparatus according to claim 1, wherein the plurality of rollers are three rollers provided at predetermined intervals in the circumferential direction, and
two rollers among the three rollers contact the outer circumferential surface.

3. The conveying apparatus according to claim 1, wherein a rotation direction of the support unit is opposite to a rotation direction of the plurality of rollers.

4. The conveying apparatus according to claim 1, wherein the plurality of rollers are provided at both ends in a width direction of the conveying belt, and contact the outer peripheral surface at both axial end portions of the battery cell.

5. The conveying apparatus according to claim 4, wherein the support unit rotates about the first rotation axis at predetermined intervals in a circumferential direction, and
each time the support unit rotates by the predetermined interval, the two rollers, among the plurality of rollers, that contact the outer peripheral surface are switched.

6. The conveying apparatus according to claim 1, wherein the conveying belt includes a concave portion provided along a width direction orthogonal to the conveying direction, and conveys the battery cell in contact with the concave portion in the conveying direction.

7. The conveying apparatus according to claim 6, wherein the battery cell is spaced apart from the concave portion and comes into contact with the plurality of rollers, when the battery cell conveyed by the conveying belt reaches the inspection position.

8. The conveying apparatus according to claim 1, wherein the second rotation mechanism rotates the support unit during rotation of the plurality of rollers.

9. The conveying apparatus according to claim 1, wherein the inspection unit inspects the outer peripheral surface of the battery cell during rotation of the plurality of rollers.
